(19) United States
(12) Patent Application Publication
(10) Pub. No.: US 2015/0113207 A1
(43) Pub. Date: Apr. 23, 2015

(54) OPERATING METHOD OF DATA STORAGE DEVICE

(71) Applicant: SK hynix Inc., Gyeonggi-do (KR)

(72) Inventor: Dong Jae SHIN, Gyeonggi-do (KR)

(73) Assignee: SK hynix Inc., Gyeonggi-do (KR)

(21) Appl. No.: 14/155,016

(22) Filed: Jan. 14, 2014

(30) Foreign Application Priority Data
Oct. 17, 2013 (KR) 10-2013-0124200

(51) Int. Cl. G06F 12/02

(52) U.S. Cl. CPC G06F 12/0246; G06F 2212/7201
USPC 711/103

(57) ABSTRACT

A method for operating a data storage device includes grouping memory blocks of a nonvolatile memory device based on program counts or erase counts of the respective memory blocks, into a first group and a second group, which has program counts or erase counts larger than the first group, performing a reprogram operation for memory blocks included in the first group, and performing a read retry operation for a selected memory cell of a memory block included in the first group or the second group, based on a read retry voltage set for each of the first group and the second group, when an error of data read from the selected memory cell is not correctable.

### CROSS-REFERENCES TO RELATED APPLICATION

The present application claims priority under 35 U.S.C, 119(a) to Korean application number 10-2013-0124200, filed on Oct. 17, 2013, in the Korean Intellectual Property Office, which is incorporated herein by reference in its entirety.

### BACKGROUND

1. Technical Field

Various embodiments of the present invention relate to a data storage device, and more particularly, to an operating method of a data storage device.

2. Related Art

Recently, the paradigm for the computer environment has changed into a ubiquitous computing in which computer systems may be used anytime and anywhere. Thus, the use of portable electronic devices such as mobile phones, digital cameras, and notebook computers has rapidly increased. In general, such portable electronic devices use a data storage device, which uses a memory device.

A data storage device using a memory device provides advantages in that, since there is no mechanical driving part, stability and durability are excellent, an information access speed is high, and power consumption is relatively low. Data storage devices having such advantages may include a universal serial bus (USB) memory device, a universal flash storage (UFS) device, a memory card having various interfaces, and a solid-state drive (SSD).

### SUMMARY

An operating method of a data storage device, which may substantially prevent a retention fail, is described herein.

In an embodiment of the present invention, a method for operating a data storage device may include grouping memory blocks of a nonvolatile memory device based on program counts or erase counts of the respective memory blocks, into a first group and a second group, which has program counts or erase counts larger than the first group, performing a reprogram operation for memory blocks included in the first group, and performing a read retry operation for a selected memory cell of a memory block included in the first group or the second group, based on a read retry voltage set for each of the first group and the second group, when an error of data read from the selected memory cell is not correctable.

In an embodiment of the present invention, a method for operating a data storage device may include grouping memory blocks of a nonvolatile memory device based on program counts or erase counts of the respective memory blocks, into a first group and a second group, which has program counts or erase counts larger than the first group, and performing a reprogram operation for memory blocks included in the first group.

In an embodiment of the present invention, a method for operating a data storage device may include grouping memory blocks of a nonvolatile memory device based on program counts or erase counts of the respective memory blocks, into a first group and a second group, which has program counts or erase counts larger than the first group, and setting a first read retry voltage corresponding to the first group and setting a second read retry voltage corresponding to the second group.

According to the embodiments of the present invention, a retention fail may be substantially prevented, and thus the reliability of a data storage device may be improved.

### BRIEF DESCRIPTION OF THE DRAWINGS

Features, aspects, and embodiments are described in conjunction with the attached drawings, in which:

FIG. 1 is a graph illustrating threshold voltage distribution of memory cells for explaining a retention fail;

FIG. 2 is a table exemplarily showing program-erase counts of memory cells;

FIG. 3 is a block diagram illustrating a data storage device in accordance with an embodiment of the present invention;

FIG. 4 is tables for explaining a memory block grouping operation in accordance with an embodiment of the present invention;

FIG. 5 is a data flow diagram for explaining a reprogram operation in accordance with an embodiment of the present invention;

FIG. 6 is a flow chart for explaining the reprogram operation in accordance with an embodiment of the present invention;

FIG. 7 is tables for explaining a method of setting read retry voltages for respective memory block groups in accordance with an embodiment of the present invention;

FIG. 8 is a graph for explaining read retry voltages in accordance with an embodiment of the present invention;

FIG. 9 is a flow chart for explaining a read retry operation in accordance with an embodiment of the present invention;

FIG. 10 is a block diagram illustrating a data processing system including a data storage device in accordance with an embodiment of the present invention;

FIG. 11 is a block diagram illustrating a data processing system including a solid-state drive (SSD) in accordance with an embodiment of the present invention;

FIG. 12 is a detailed diagram of an SSD controller shown in FIG. 11; and

FIG. 13 is a block diagram illustrating a computer system including a data storage device in accordance with the embodiment of the present invention.

### DETAILED DESCRIPTION

In the present invention, advantages, features and methods for achieving them will become more apparent after a reading of the following exemplary embodiments taken in conjunction with the drawings, The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention. Throughout the disclosure, reference numerals correspond directly to the like numbered parts in the various figures and embodiments of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

Hereinafter, an operating method of a data storage device according to the present invention will be described below with reference to the accompanying drawings through exemplary embodiments.

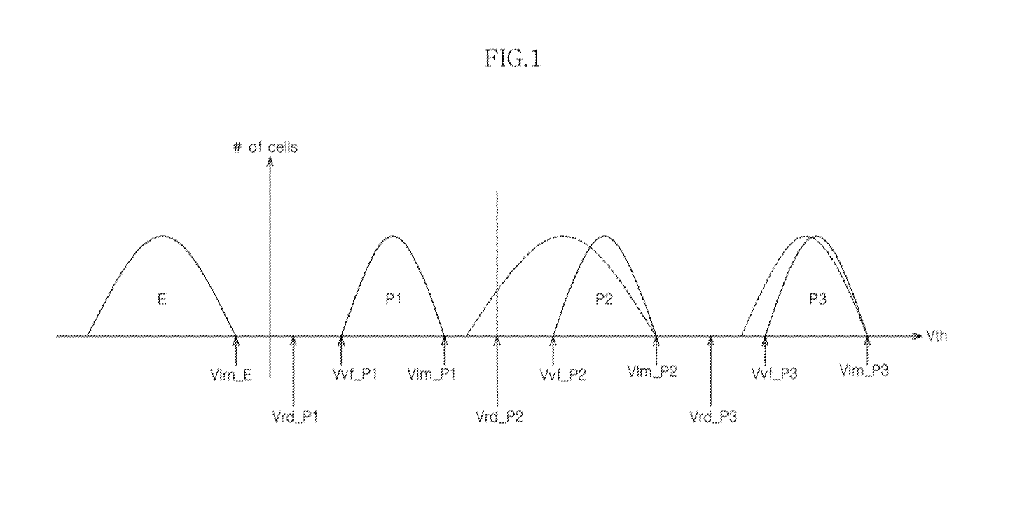

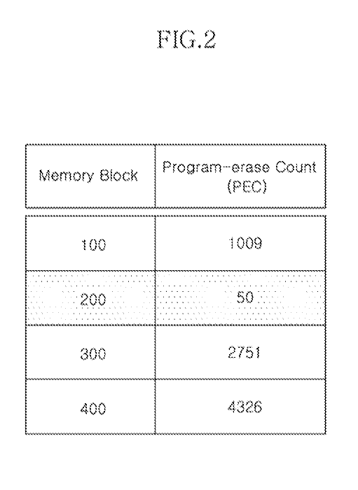

FIG. 1 is a graph illustrating threshold voltage distribution of memory cells for explaining a retention fail. Further, FIG. 2 is a table exemplarily showing program-erase counts of memory cells that have influence on the retention fail. In explaining FIGS. 1 and 2, for the sake of convenience in explanation, each of respective memory cells is exemplified as a multi-level cell (MLC) capable of storing 2-bit data.

Multi-level cells capable of storing 2-bit data per cell may be erased to have an erased state E or may be programmed to have any one of programmed states P1, P2 and P3. For instance, if a memory cell is erased, the erased memory cell may have a threshold voltage equal to or lower than an erase verification voltage Vim_E. For another instance, if a memory cell is programmed, the programmed memory cell may have a threshold voltage between a first program verification voltage Vvf_P1 and a first program limit voltage Vim_P1, may have a threshold voltage between a second program verification voltage Vvf_P2 and a second program limit voltage Vlm_P2, or may have a threshold voltage between a third program verification voltage Vvf_P3 and a third program limit voltage Vlm_P3. The respective program verification voltages used for verifying whether or not a memory cell is programmed to a corresponding programmed state.

If a read operation is performed for a programmed memory cell, any one of read voltages Vrd_P1, Vrd_P2 and Vrd_P3 may be provided to the word line of a selected memory cell, The first read voltage Vrd_P1 may have a voltage level between the erased state E and the first programmed state P1. The second read voltage Vrd_P2 may have a voltage level between the first programmed state P1 and the second programmed state P2. The third read voltage Vrd_P3 may have a voltage level between the second programmed state P2 and the third programmed state P3.

For instance, if the first read voltage Vrd_P1 is applied, memory cell with the threshold voltage of the erased state E may be sensed as an ‘on’ cell, and a memory cell with the threshold voltage of any one of the first to third programmed states P1, P2 and P3 may be sensed as an ‘off’ cell. For another instance, if the second read voltage Vrd_P2 is applied, a memory cell with the threshold voltage of any one of the erased state E and the first programmed state P1 may be sensed as an ‘on’ cell, and a memory cell with the threshold voltage of any one of the second and third programmed states P2 and P3 may be sensed as an ‘off’ cell. For still another instance, if the third read voltage Vrd_P3 is applied, a memory cell with the threshold voltage of any one of the erased state E, the first programmed state P1. and the second programmed state P2 may be sensed as an ‘on’ cell, and a memory cell with the threshold voltage of the third programmed state P3 may be sensed as an ‘off’ cells

As the program count or the erase count (hereinafter, referred to as a program-erase count (PEC)) of a memory cell increases, the memory cell may be degraded. If a memory cell is degraded, charges charged in the memory cell may leak although the memory cell has a nonvolatile characteristic. A characteristic for retaining charged charges within a predetermined specification, that is, a characteristic for retaining the threshold voltage of a memory cell, is referred to as the retention characteristic of the memory cell. Since a memory cell with a poor retention characteristic may not retain a programmed state, a read fail may occur.

If the retention characteristic of a memory cell is degraded, the threshold voltage of the memory cell may be gradually decreased. That is, as can be seen from the threshold voltage distribution shown by the dotted line in FIG. 1, the threshold voltage of the memory cell may not retain an original threshold voltage and may be gradually decreased. If the threshold voltage of the memory cell is decreased, the memory cell to be recognized as an ‘off’ cell may be read as an ‘on’ cell. For example, if the threshold voltage of a memory cell, which is programmed to the second programmed state P2 is decreased lower than the second read voltage Vrd_P2 due to degradation of the retention characteristic, such a memory cell may be sensed as having the erased state E or the first programmed state P1. For this reason, the memory cell with the degraded retention characteristic may cause a read fail. In respect of an error correction algorithm, the data read from the memory cell with the degraded retention characteristic may be determined as including an error,

It is assumed that other memory cells are programmed and erased while a programmed memory cell is left without being refreshed or reprogrammed. In such case, the program-erase count (PEC) of the memory cell, which is left for a lengthy period of time after being programmed, may be smaller than that of the memory cells not left as they are. Referring to FIG. 2, since a memory block 200 is left for a lengthier period of time than the other memory blocks 100, 300 and 400, the program-erase count 50 of the memory block 200 may be smaller than the program-erase counts 1009, 2751 and 4326 of the other memory blocks 100, 300 and 400.

A memory cell left for a lengthy period of time after being programmed may be degraded in its retention characteristic due to the leakage of charged charges, and thus it is highly likely to cause a read fail. For example, the retention characteristics of memory cells included in the memory block 200 with a relatively small program-erase count may be more degraded than that of memory cells included in the memory blocks 100, 300 and 400 with relatively large program-erase counts. Further, due to the degraded retention characteristics, the memory cells included in the memory block 200 may have higher probabilities to cause read fails than the memory cells included in the other memory blocks 100, 300 and 400.

In the following descriptions, a memory cell with a small program-erase count (or a memory block including such a memory cell) is considered as being more degraded in its retention characteristic than a memory cell with a relatively large program-erase count (or a memory block including such a memory cell). Further, due to the degraded retention characteristic, the memory cell with a small program-erase count (or the memory block including such a memory cell) is considered as having a high probability to cause a retention fail, that is, a read fail.

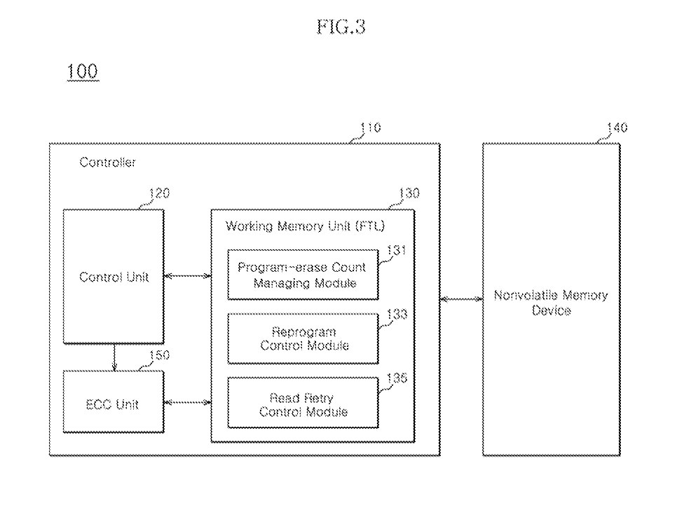

FIG. 3 is a block diagram illustrating a data storage device 100 in accordance with an embodiment of the present invention. The data storage device 100 may operate in response to a request from a host device (not shown) such as a mobile phone, an MP3 player, a digital camera, a laptop computer, a desktop computer, a game player, a TV and a car entertainment system. The data storage device 100 may store data to be accessed by the host device. The data storage device 100 may also be referred to as a memory system.

The data storage device 100 may be any one of various kinds of storage devices according to the protocol of an interface (I/F), which is coupled with the host device. For example, the data storage device 100 may be configured as any one of various kinds of storage devices such as a solid-state drive, a multimedia card (e.g. an MMC, an eMMC, an RS-MMC and a micro-MMC), a secure digital card (e.g., an SD, a mini-SD and an micro-SD), a universal serial bus (USB) storage device, a universal flash storage (UFS) device, a personal computer memory card international association (PCMCIA) card type storage device, a peripheral component interconnection (PCI) card type storage device, a PCI express (PCI-E) card type storage device, a compact flash (CF) card, a smart media card, a memory stick, and so forth.

Referring to FIG. 3, the data storage device 100 may include a controller 110 and a nonvolatile memory device 140.

The controller 110 may control the nonvolatile memory device 140 in response to a request from the host device. For example, the controller 100 may provide the data read from the nonvolatile memory device 140 to the host device. For another example, the controller 100 may store the data provided from the host device, in the nonvolatile memory device 140. For these operations, the controller 100 may control the read, write (or program) and erase operations of the nonvolatile memory device 140.

The nonvolatile memory device 140 may operate as the storage medium of the data storage device 100. Hereinbelow, the nonvolatile memory device 140 may be referred to as a (NAND type) flash memory device 140. However, the nonvolatile memory device 140 may include any one of various types of nonvolatile memory devices such as a NOR type flash memory device, a ferroelectric random access memory (FRAM) using ferroelectric capacitors, a magnetic random access memory (MRAM) using a tunneling magneto-resistive (TMR) layer, a phase change random access memory (PRAM) using a chalcogenide alloy, and a resistive random access memory (ReRAM) using a transition metal oxide. Furthermore, the nonvolatile memory device 140 may include a combination of a NAND type flash memory device and one or more of the various types of nonvolatile memory devices described above.

The controller 110 may drive firmware (or software) for controlling the general operations of the data storage device 100. The flash memory device 140 may perform a read or program operation by the unit of a page according to the structural characteristics thereof. Further, the flash memory device 140 may perform an erase operation by the unit of a block. Also, the flash memory device 140 may not perform overwriting. Due to such characteristics of the flash memory device 140, the controller 110 may drive an additional firmware or software), which is referred to as a flash translation layer (FTL).

The controller 110 may include a control unit 120, a working memory unit 130, and an error correction code (ECC) unit 150. Although not shown, the controller 110 may further include function blocks such as a host interface, a memory interface, a power supply unit and a clock supply unit.

The working memory unit 130 may store firmware (or software) and a flash translation layer (FTL) to be driven by the control unit 120. Further the working memory unit 130 may store data used to drive the firmware (or the software) and the flash translation layer. In addition, the working memory unit 130 may temporarily store data to be transmitted between the host device and the flash memory device 140. Namely, the working memory unit 130 may operate as a buffer memory or a cache memory.

The ECC unit 150 may detect and correct an error of the data read from the flash memory device 140. The ECC unit 150 may be realized in hardware type and/or software type.

The control unit 120 may control the general operations of the controller 110 through driving of the firmware (or the software) and the flash translation layer, which are loaded on the working memory unit 130. The control unit 120 may decode and drive code type algorithms such as the firmware (or the software) and the flash translation layer. The control unit 120 may be realized in the combined type of hardware and software. Further, the control unit 120 may include a micro control unit (MCU) and a central processing unit (CPU).

The flash translation layer (FTL) loaded on the working memory unit 130 may manage the operations of the flash memory device 140 such that the data storage device 100 may respond to accesses, for example, read and write operations, requested from the file system of the host device. The flash translation layer may include code type modules, which are classified depending on functions to be performed

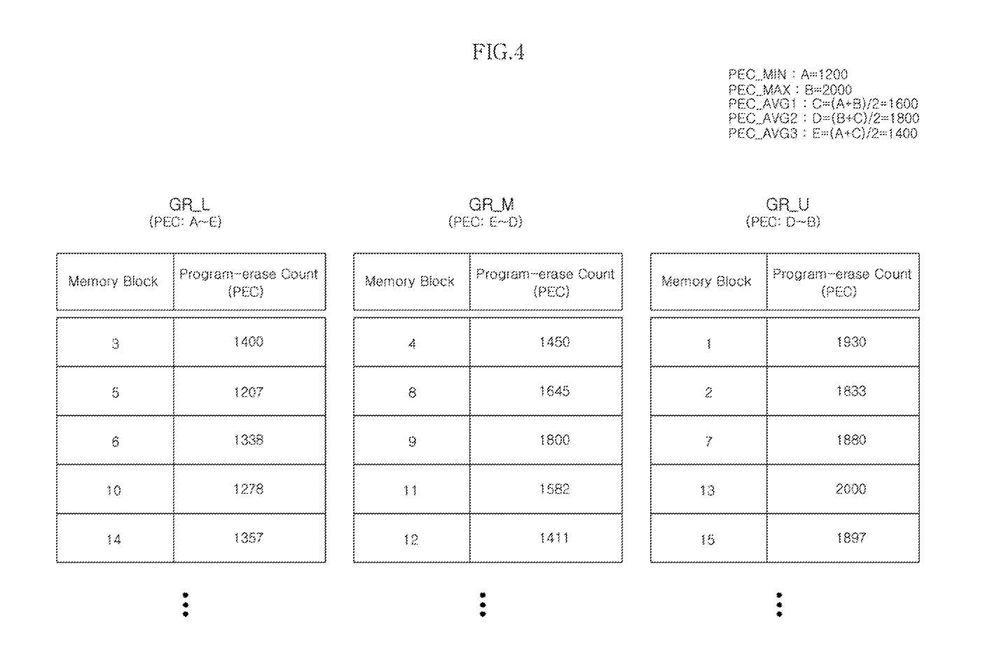

The flash translation layer may include a program-erase count (PEC) managing module 131. The program-erase count managing module 131 may manage a program-erase count (PEC) by the unit of the memory block of the flash memory device 140 to identify a retention characteristic. Further, the program-erase count managing module 131 may group memory blocks based on program-erase counts. For example, the program-erase count managing module 131 may arrange memory blocks with relatively large program-erase counts into a group, memory blocks with relatively small program-erase counts into a group, and remaining memory blocks into a group. The memory block grouping operation to be performed by the program-erase count managing module 131 will be described in detail with reference to FIG. 4.

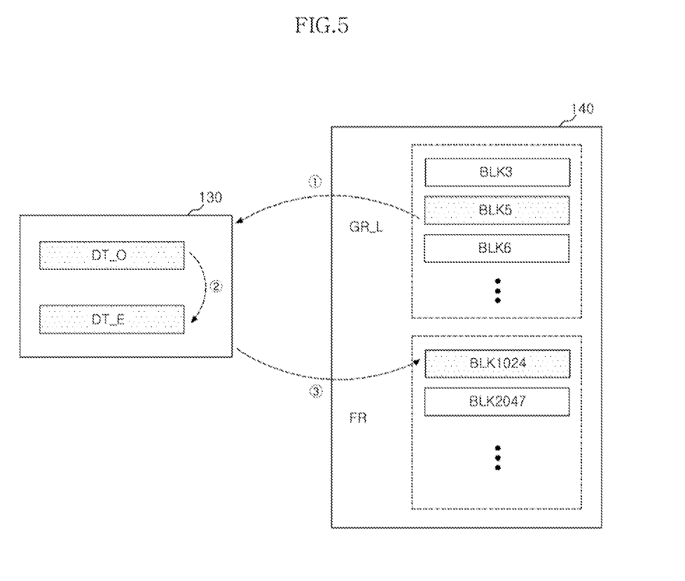

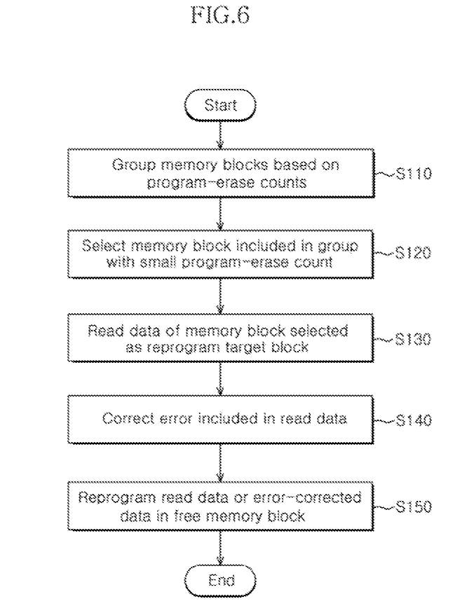

Further, the flash translation layer may include a reprogram control module 133. The reprogram control module 133 may select a memory block, which is to be reprogrammed, based on the program-erase counts managed by the program-erase count managing module 131. The reprogram control module 133 may perform a reprogram operation for the selected memory block. The reprogram operation to be performed by the reprogram control module 133 will be described with reference to FIGS. 5 and 6.

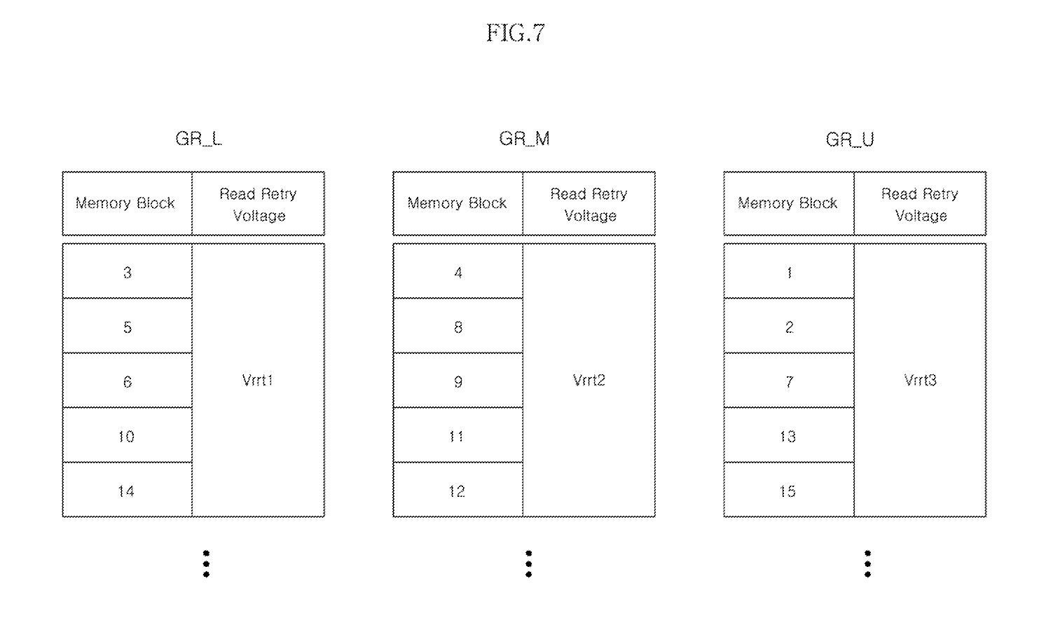

In addition, the flash translation layer may include a read retry control module 135. The read retry control module 135 may set read retry voltages corresponding to respective memory blocks, based on the program-erase counts managed by the program-erase count managing module 131. The read retry control module 135 may perform a read retry operation for a memory block for which the read retry operation is to be performed, by using a set read retry voltage. The read retry operation to be performed by the read retry control module 135 will be described in detail with reference to FIGS. 7 to 9.

Although not shown in FIG. 3, the flash translation layer (FTL) may perform additional managing operations due to the characteristics of the flash memory device 140. For instance, the flash translation layer may manage a garbage collecting operation due to the incapability of overwrite. For another instance, the flash translation layer may manage a wear-leveling operation due to the limitation in a program-erase count. For another instance, the flash translation layer may manage a bad block managing operation due to the allowance of a block with a defect. For another instance, the flash translation layer may manage an address mapping operation for converting the logical addresses of the host device (not shown) into the physical addresses of the flash memory device 140.

FIG. 4 is tables for explaining a memory block grouping operation in accordance with the embodiment of the present invention. In explaining FIG. 4, for the sake of simplification of explanation, it is assumed that the memory blocks of the flash memory device 140 are grouped into three groups GR_L, GR_M and GR_U. However, the number of groups may be changed. Also, in explaining FIG. 4, it is assumed that the wear degrees of the memory blocks of the flash memory device 140 are leveled by a wear-leveling technique. For instance, it is assumed that the memory blocks have program-erase counts between a minimum value A of 1200 and a maximum value B of 2000.

The program-erase count managing module 131 may manage a program-erase count (PEC) by the unit of a memory block to identify a retention characteristic. The program-erase count managing module 131 may group memory blocks based on program-erase counts. That is, the program-erase count managing module 131 may arrange memory blocks into groups based on the program-erase counts.

For example, the program-erase count managing module 131 may arrange memory blocks 3, 5, 6, 10, 14, . . . , which have relatively small program-erase counts, into a lower program-erase count group GR_L. The memory blocks included in the lower PEC group GR_L may have program-erase counts between the minimum program-erase count A and a third average program-erase count E of 1400.

For another example, the program-erase count managing module 131 may arrange memory blocks 4, 8, 9, 11, 12, . . . , which have average program-erase counts, into a middle program-erase count group GR_M. The memory blocks included in the middle PEC group GR_M may have program-erase counts between the third average program-erase count E and a second average program-erase count D of 1800.

For still another example, the program-erase count managing module 131 may arrange memory blocks 1, 2, 7, 13, 15, . . . , which have relatively large program-erase counts, into an upper program-erase count group GR_U. The memory blocks included in the upper PEC group GR_U may have program-erase counts between the second average program-erase count D and the maximum program-erase count B.

By grouping memory blocks in this way, the mean program-erase count of the memory blocks included in the lower PEC group GR_L may be smaller than the mean program-erase count of the memory blocks included in the middle PEC group GR_M. Further, the mean program-erase count of the memory blocks included in the middle PEC group GR_M may be smaller than the mean program-erase count of the memory blocks included in the upper PEC group GR_U. In other words, grouping may be performed in such a manner that the mean program-erase counts decrease from the upper PEC group GR_U to the lower PEC group GR_L.

By grouping memory blocks based on program-erase counts, the memory blocks may be sorted into memory blocks with degraded retention characteristics, memory blocks with average retention characteristics, and memory blocks with undegraded retention characteristics.

For instance, the memory blocks of the lower PEC group GR_L, which have relatively small program-erase counts when compared to the memory blocks included in the other groups GR_M and GR_U, may be sorted as memory blocks having retention characteristics that are degraded as described above with reference to FIGS. 1 and 2. Namely, the memory blocks included in the lower PEC group GR_L may be sorted as memory blocks, which have a high probability to cause a read fail, due to degradation of retention characteristics.

For another instance, the memory blocks of the middle PEC group GR_M, which have average program-erase counts when compared to the memory blocks included in the other groups GR_L and GR_U, may be sorted as memory blocks having average retention characteristics. Namely, the memory blocks included in the middle PEC group GR_M may be sorted as memory blocks, which have an average probability to cause a read fail.

For still another instance, the memory blocks of the upper PEC group GR_U, which have relatively large program-erase counts when compared to the memory blocks included in the other groups GR_L and GR_M, may be sorted as memory blocks having degraded retention characteristics. Namely, the memory blocks included in the upper PEC group GR_U may be sorted as memory blocks, which have a low probability to cause a read fail. In other embodiments of the present invention, the memory blocks may be arranged into two or more than three memory block groups based on program-erase counts.

FIG. 5 is a data flow diagram for explaining a reprogram operation in accordance with an embodiment of the present invention.

As described above with reference to FIG. 4, the memory blocks included in the lower PEC group GR_L may be memory blocks, which have a high probability to cause a read fail, due to degradation of retention characteristics. The memory blocks included in the lower PEC group GR_L is to be reprogrammed prior to the memory blocks included in the other groups GR_M and GR_U. Therefore, the reprogram control module 133 may select the lower PEC group GR_L, which has a high probability to cause a read fail, due to degradation of retention characteristics, as a reprogram target.

If there is a sufficient time margin to perform a reprogram operation, that is, when an idle time with no job requested from the host device (not shown) continues long, the reprogram control module 133 may select all the memory blocks included in the lower PEC group GR_L, as reprogram targets. If there is no sufficient time margin to perform a reprogram operation, that is, when an idle time with no job requested from the host device (not shown) continues short, the reprogram control module 133 may select a memory block, which needs to be urgently reprogrammed among the memory blocks included in the lower PEC group GR_L, as a reprogram target. For example, the reprogram control module 133 may select a reprogram target in order of small program-erase count among the memory blocks included in the lower PEC group GR_L.

Referring to FIG. 5, it is assumed that a memory block BLK5 with the smallest program-erase count among the memory blocks included in the lower PEC group GR_L is selected as a reprogram target.

The reprogram control module 133 may control data DT_O stored in the memory block BLK5 selected as a reprogram target block, to be read from the flash memory device 140 to the working memory unit 130 (process \textcircled{1}).

The threshold voltages of memory cells may vary due to degradation of the retention characteristic of the memory block BLK5, and for this reason, data read as data different from original data may exist in the read data DT_O. That is, the read data DT_O may include an error. The reprogram control module 133 may control the error included in the read data DT_O, to be corrected through the ECC unit 150 (process \textcircled{2}). For instance, the error included in the read data DT_O may be corrected before the read data DT_O is stored in the working memory unit 130, and error-corrected data DT_E may be stored in the working memory unit 130.

The operation of generating the error-corrected data DT_E by correcting the error included in the read data DT_O may be omitted depending on the number of errors included in the read data D_O.

The reprogram control module 133 may control the read data DT_O or the error-corrected data DT_E to be stored from the working memory unit 130 to the flash memory device 140 (process \textcircled{3}). The reprogram control module 133 may control the data DT_O, to be stored in a free memory block BLK1024 other than the memory block BLK5 from which it is read. The free memory block BLK1024 is selected in any one of free memory blocks FR.

FIG. 6 is a flow chart for explaining the reprogram operation in accordance with an embodiment of the present invention.

With reference to FIG. 6, a reprogram operation of the controller 110 for preventing the occurrence of a read fail likely to be caused due to degradation of the retention characteristic of the flash memory device 140 will be described, The reprogram operation of the controller 110 may be performed for an idle time with no job requested from the host device (not shown).

In step S110, the controller 110 may group the memory blocks of the flash memory device 140 based on program-erase counts (PEC). For instance, the controller 110 may arrange memory blocks with relatively smaller program-erase counts than the other memory blocks, as one group.

In step S120, the controller 110 may select a memory block, which is included in a group with small program-erase counts, as a reprogram target block. For instance, the controller 110 may select, one by one, all memory blocks, which are included in the group with small program-erase counts, as a reprogram target block. For another instance, the controller 110 may select at least one of memory blocks, which are included in the group with small program-erase counts, as a reprogram target block.

In step S130, the controller 110 may read the data of the memory block selected as the reprogram target block. For instance, the read data may be temporarily stored in the working memory unit 130 of the controller 110.

In step S140, the controller 110 may correct the error included in the read data. For instance, the error included in the read data may be detected and corrected by the ECC unit 150. The controller 110 may selectively perform a correcting operation for the error included in the read data, depending on the number of errors included in the read data. That is, the step S140 may be omitted.

In step S150, the controller 110 may reprogram the read data or the error-corrected data in a free memory block of the flash memory device 140.

Through such series of steps, the controller 110 may prevent the occurrence of a read fail in the flash memory device 140, which is otherwise likely to be caused due to degradation of the retention characteristic of the flash memory device 140.

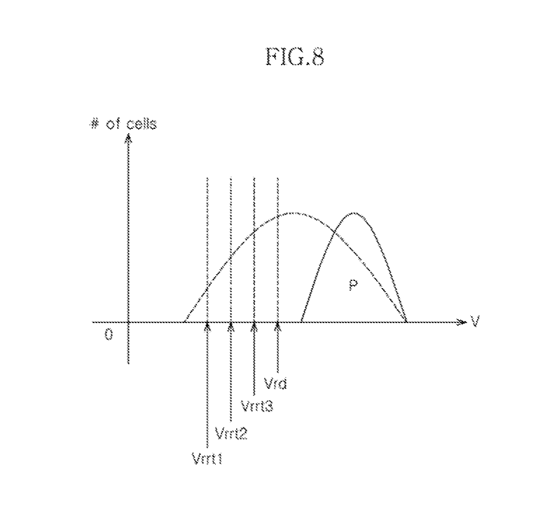

FIG. 7 is tables for explaining a method for setting read retry voltages in respective memory block groups in accordance with an embodiment of the present invention. FIG. 8 is a graph for explaining the read retry voltages in accordance with the embodiment of the present invention.

In explaining FIGS. 7 and 8, as described above with reference to FIG. 4, the memory blocks of the flash memory device 140 are grouped based on program-erase counts. In other words, it is assumed that memory blocks are arranged into a lower PEC group GR_L with relatively small program-erase counts, a middle PEC group GR_M with average program-erase counts, and an upper PEC group GR_U with relatively large program-erase counts. However, in other embodiments of the present invention, the memory blocks of the flash memory device 140 may be arranged into two or more than three memory block groups based on program-erase counts.

The threshold voltage of a memory cell with a degraded retention characteristic (or a memory block including such a memory cell) will be lower than the threshold voltage of a normal memory cell. If such a memory cell is read using a read voltage that is lower than a normal read voltage, the memory cell may be read as a normal state, that is, as a programmed state (or as an ‘off’ cell). By using such a fail repair mechanism, read retry voltages Vrrt may be set for memory blocks grouped based on program-erase counts (PEC). Namely, read retry voltages Vrrt to be used when a read retry operation is performed may be set for the respective groups GR_L, GR_M and GR_U.

For instance, the memory blocks of the lower PEC group GR_L, which have relatively smaller program-erase counts than the memory blocks included in the other groups GR_M and GR_U may be sorted as memory blocks having retention characteristics that are degraded as described above with reference to FIGS. 1 and 2. Therefore, as shown in FIG. 7, a first read retry voltage Vrrt1 may be set for the memory blocks of the lower PEC group GR_L. The first read retry voltage Vrrt1 set for the lower PEC group GR_L may be used as an initial read retry voltage when a read retry operation is performed for the memory blocks of the lower PEC group GR_L.

For another instance, the memory blocks of the middle PEC group GR_M, which have average program-erase counts when compared to the memory blocks included in the other groups GR_L and GR_U, may be sorted as memory blocks having retention characteristics that are average. Therefore, as shown in FIG. 7, a second read retry voltage Vrrt2 may be set for the memory blocks of the middle PEC group GR_M, The second read retry voltage Vrrt2 set for the middle PEC group GR_M may be used as an initial read retry voltage when a read retry operation is performed for the memory blocks of the middle PEC group GR_M.

For still another instance, the memory blocks of the upper PEC group GR_U, which have relatively larger program-erase counts than the memory blocks included in the other groups GR_L and GR_M, may be sorted as memory blocks having retention characteristics that are not degraded. Therefore, as shown in FIG. 7, a third read retry voltage Vrrt3 may be set for the memory blocks of the upper PEC group GR_U. The third read retry voltage Vrrt3 set for the upper PEC group GR_U may be used as an initial read retry voltage when a read retry operation is performed for the memory blocks of the upper PEC group GR_U.

As a degree of degradation in the retention characteristic of a memory cell increases, the threshold voltage of the memory cell decreases. Thus, only when a read retry operation is performed using a lower read retry voltage for a memory cell, which has a larger degree of degradation in the retention characteristic thereof, the occurrence of a read fail in such a memory cell may be prevented. Therefore, the levels of voltages increase from the first read retry voltage Vrrt1 to the third read retry voltage Vrrt3. Only when a read retry operation is performed using the read retry voltage Vrrt1, Vrrt2 or Vrrt3 having a voltage level that is lower than a read voltage Vrd, the number of memory cells, which fail in reading due to degradation of retention characteristics thereof, may be decreased or the occurrence of read fails may be prevented. Hence, the read retry voltages Vrrt1, Vrrt2 and Vrrt3 have voltage levels lower than the read voltage Vrd.

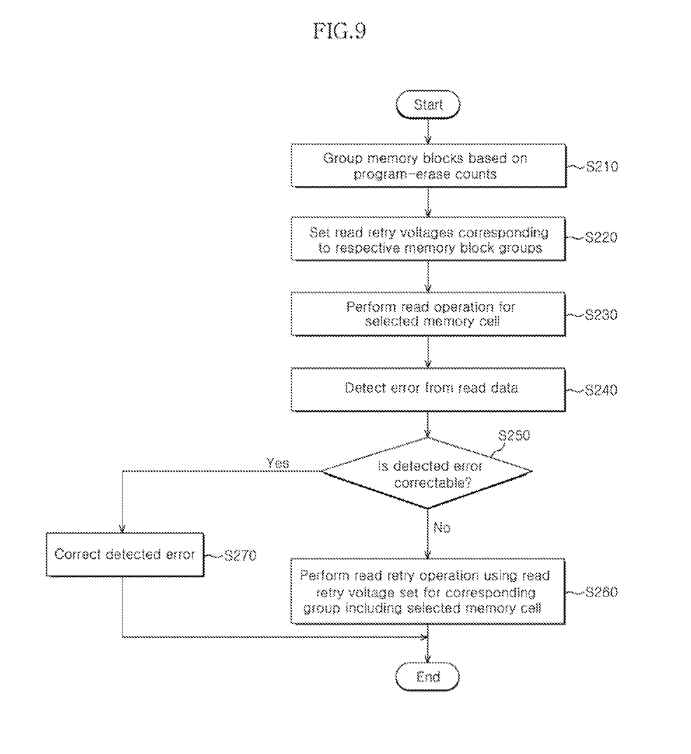

FIG. 9 is a flow chart for explaining a read retry operation in accordance with an embodiment of the present invention.

With reference to FIG. 9, a read retry operation of the controller 110 for preventing the occurrence of a read fail, which is otherwise likely to be caused due to degradation in the retention characteristic of the flash memory device 140 will be described.

In step S210, the controller 110 may group the memory blocks of the flash memory device 140 based on program-erase counts (PEC). For instance, the controller 110 may arrange memory blocks with relatively smaller program-erase counts than the other memory blocks, as one group, and may arrange memory blocks with relatively larger program-erase counts than the other memory blocks, as one group.

In step S220, the controller 110 may set read retry voltages for the respective memory block groups. For instance, the controller 110 may set a first read retry voltage to a first group, which has relatively smaller program-erase counts, and may set a second read retry voltage larger than the first read retry voltage, to a second group, which has relatively larger program-erase counts than the first group.

In step S230, the controller 110 may perform a read operation for a selected memory cell.

In step S240, the controller 110 may detect an error from the read data

In step S250, the controller 110 may determine whether a detected error is correctable, through the ECC unit 150. Based on the determination result, the process may be branched into step S260 or step S270.

In step S270, when the detected error is correctable, the controller 110 may correct the detected error. If the detected error is corrected, a read operation may be ended.

In step S260, when the detected error is not correctable, the controller 110 may perform a read retry operation using a read retry voltage set for the corresponding group in which the selected memory cell is included. That is, the controller 110 may control the flash memory device 140 in such a manner that the read retry voltage set for the group in which the selected memory cell is included is applied to the selected memory cell and a read operation for the selected memory cell is performed again by using the applied read retry voltage.

The read retry operation may be repeatedly performed. The read retry voltage set for the group in which the selected memory cell is included may be used as an initial read retry voltage. Each time the read retry operation is repeated, a read retry voltage that is lower than the initial read retry voltage may be applied to the selected memory cell.

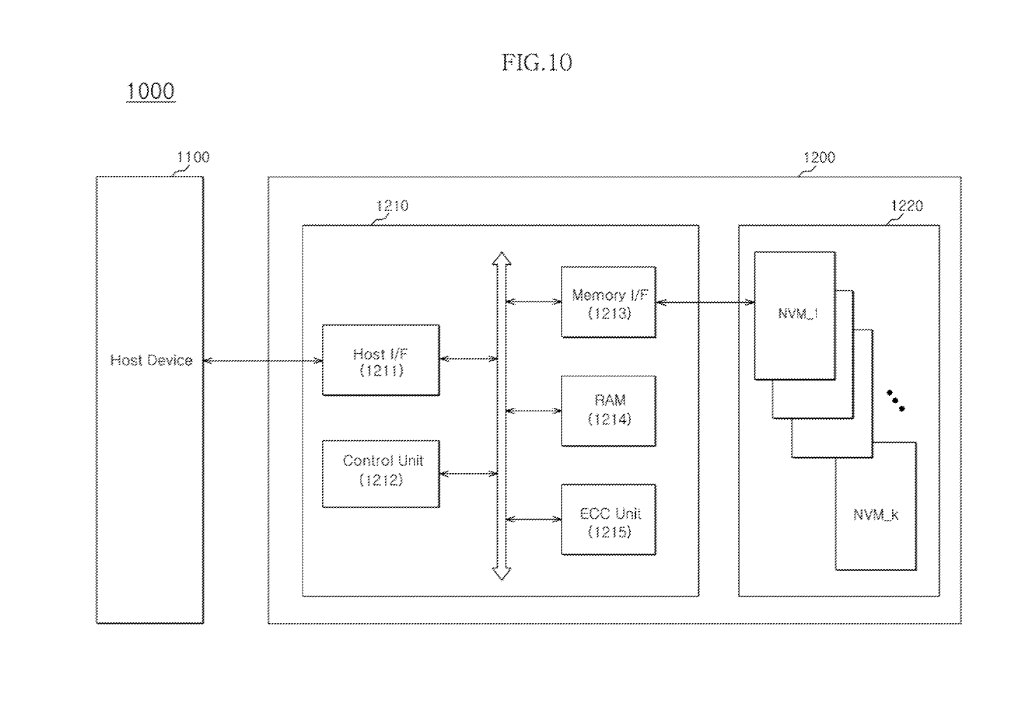

FIG. 10 is a block diagram illustrating a data processing system 1000 including the data storage device in accordance with the embodiment of the present invention.

Referring to FIG. 10, the data processing system 1000 may include a host device 1100 and a data storage device 1200.

The data storage device 1200 may include a controller 1210 and a nonvolatile memory device 1220. The data storage device 1200 may be used by being electrically coupled to the host device 1100 such as a desktop computer, a notebook computer, a digital camera, a mobile phone, an MP3 player, a game player, and so forth. The data storage device 1200 is also referred to as a memory system.

The controller 1210 may access the nonvolatile memory device 1220 in response to a request from the host device 1100. For example, the controller 1210 may control the read, program or erase operation of the nonvolatile memory device 1220. The controller 1210 may drive firmware (or software) for controlling the nonvolatile memory device 1220.

The controller 1210 may perform the reprogram operation in accordance with the embodiment of the present invention. That is, the controller 1210 may group the memory blocks of the nonvolatile memory device 1220, and may perform the reprogram operation for a group with a small program-erase count (PEC). Also, the controller 1210 may perform the read retry operation in accordance with the embodiment of the present invention. That is, the controller 1210 may group the memory blocks of the nonvolatile memory device 1220, and may perform the read retry operation using read retry voltages, which are set for the respective groups.

The controller 1210 may include a host interface (I/F) 1211, a control unit 1212, a memory interface (1/F) 1213, a RAM 1214, and an error correction code (ECC) unit 1215.

The control unit 1212 may control the general operations of the controller 1210 in response to a request from the host device 1100. The RAM 1214 may be used as the working memory of the control unit 1212. The RAM 1214 may temporarily store the data read from the nonvolatile memory device 1220 or the data provided from the host device 1100.

The host interface 1211 may interface the host device 1100 and the controller 1210. For example, the host interface 1211 may communicate with the host device 1100 through one of various interface protocols such as a universal serial bus (USB) protocol, a universal flash storage (UFS) protocol, a multimedia card (MMC) protocol, a peripheral component interconnection (PCI) protocol, a PCI express (PCI-E) protocol, a parallel advanced technology attachment (PATA) protocol, a serial advanced technology attachment (SATA) protocol, a small computer system interface (SCSI) protocol, and a serial attached SCSI (SAS) protocol.

The memory interface 1213 may interface the controller 1210 and the nonvolatile memory device 1220. The memory interface 1213 may provide a command and an address to the nonvolatile memory device 1220. Furthermore, the memory interface 1213 may exchange data with the nonvolatile memory device 1220.

The error correction code unit 1215 may detect an error of the data read from the nonvolatile memory device 1220. Also, the error correction code unit 1215 may correct the detected error when the detected error falls within a correctable range. Meanwhile, the error correction code unit 1215 may be provided inside or outside the controller 1210 depending on the memory system 1000.

The nonvolatile memory device 1220 may be used as the storage medium of the data storage device 1200. The nonvolatile memory device 1220 may include a plurality of nonvolatile memory chips (or dies) NVM_{—}1 to NVM_k.

The controller 1210 and the nonvolatile memory device 1220 may be any one of various data storage devices. For example, the controller 1210 and the data storage medium 1220 may be integrated into one semiconductor apparatus and may be any one of a multimedia card (e.g., an MMC, an eMMC, an RS-MMC and a micro-MMC), a secure digital card (e.g., an SD, a mini-SD and an micro-SD), a universal serial bus (USB) storage device, a universal flash storage (UFS) device, a personal computer memory card international association (PCMCIA) card, a compact flash (CF) card, a smart media card, and a memory stick.

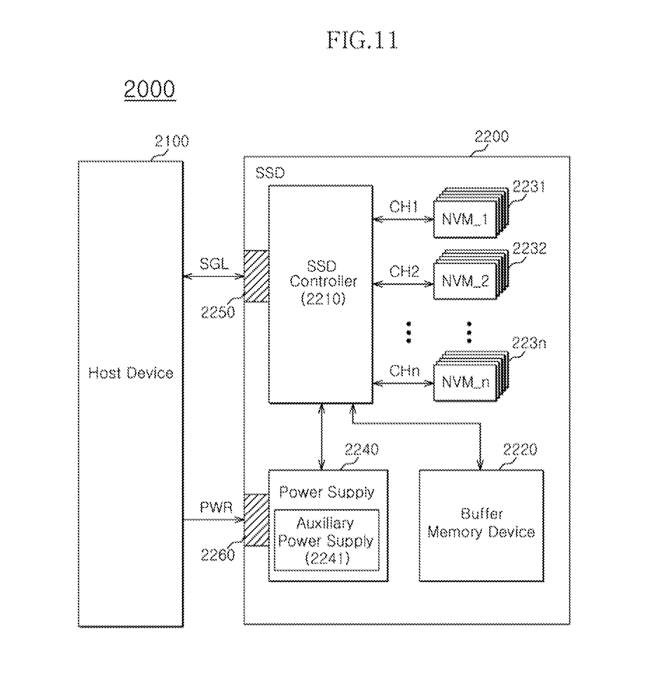

FIG. 11 is a block diagram illustrating a data processing system including a solid-state drive (SSD) in accordance with an embodiment of the present invention.

Referring to FIG. 11, a data processing system 2000 may include a host device 2100 and an SSD 2200.

The SSD 2200 may include an SSD controller 2210, the buffer memory device 2220, nonvolatile memory devices 2231 to 223n, a power supply 2240, a signal connector 2250, and a power connector 2260.

The SSD 2200 may operate in response to a request from the host device 2100. That is, the SSD controller 2210 may access the nonvolatile memory devices 2231 to 223n in response to a request from the host device 2100. For example, the SSD controller 2210 may control the read, program and erase operations of the nonvolatile memory devices 2231 to 223n.

The SSD controller 2210 may perform a reprogram operation in accordance with the embodiment of the present invention. That is, the SSD controller 2210 may group the memory blocks of the nonvolatile memory devices 2231 to 223n, and may perform the reprogram operation for a group with a small program-erase count (PEC). Also, the SSD controller 2210 may perform a read retry operation in accordance with the embodiment of the present invention. That is, the SSD controller 1210 may group the memory blocks of the nonvolatile memory devices 2231 to 223n, and may perform the read retry operation using read retry voltages, which are set for the respective groups.

The buffer memory device 2220 may temporarily store data to be stored in the nonvolatile memory devices 2231 to 223n. Further, the buffer memory device 2220 may temporarily store data read from the nonvolatile memory devices 2231 to 223n. The data temporarily stored in the buffer memory device 2220 may be transmitted to the host device 2100 or the nonvolatile memory devices 2231 to 223n under the control of the SSD controller 2210,

The nonvolatile memory devices 2231 to 223n may be used as storage media of the SSD 2200. The nonvolatile memory devices 2231 to 223n may be electrically coupled to the SSD controller 2210 through a plurality of channels CH1 to CHn, respectively. One or more nonvolatile memory devices may be electrically coupled to one channel. The nonvolatile memory devices electrically coupled to one channel may be electrically coupled to the same signal bus and data bus.

The power supply 2240 may provide power PWR inputted through the power connector 2260, to the inside of the SSD 2200. The power supply 2240 may include an auxiliary power supply 2241. The auxiliary power supply 2241 may supply power to allow the SSD 2200 to be normally terminated when a sudden power-off occurs. The auxiliary power supply 2241 may include super capacitors capable of being charged with power PWR.

The SSD controller 2210 may exchange a signal (i.e., SGL) with the host device 2100 through the signal connector 2250. The signal SGL may include a command, an address, data, and so forth. The signal connector 2250 may include a connector such as of a parallel advanced technology attachment (PATA) protocol, a serial advanced technology attachment (SATA) protocol, a small computer system interface (SCSI) protocol, a serial attached SCSI (SAS) protocol, a peripheral component interconnection (PCI) protocol, and a PCI express (PCI-E) protocol, depending on an interface scheme between the host device 2100 and the SSD 2200.

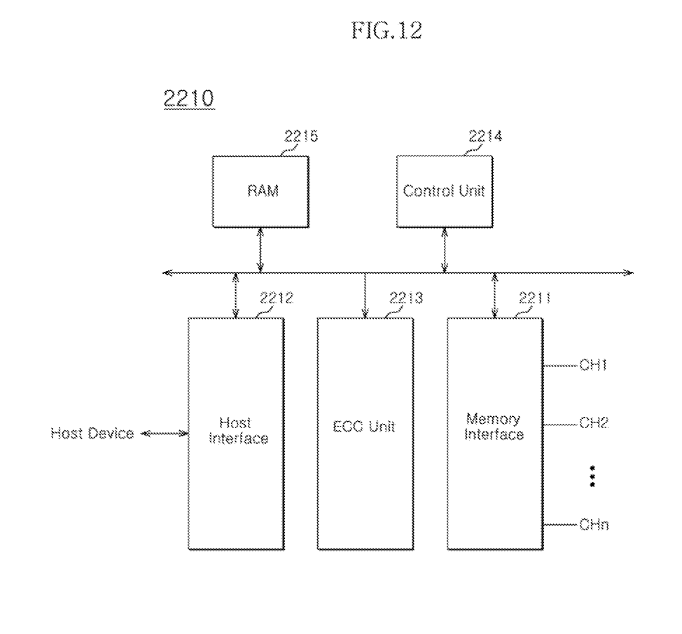

FIG. 12 is a detailed block diagram of the SSD controller shown in FIG. 11.

Referring to FIG. 12, the SSD controller 2210 may include a memory interface 2211, a host interface 2212, an error correction code (ECC) unit 2213, a control unit 2214, and a RAM 2215.

The memory interface 2211 may provide a command and an address to the nonvolatile memory devices 2231 to 223n. Moreover, the memory interface 2211 may exchange data with the nonvolatile memory devices 2231 to 223n. The memory interface 2211 may scatter the data transmitted from the buffer memory device 2220 to the respective channels CH1 to CHn, under the control of the control unit 2214. Furthermore, the memory interface 2211 may transfer the data read from the nonvolatile memory devices 2231 to 223n to the buffer memory device 2220, under the control of the control unit 2214.

The host interface 2212 may provide an interface with the SSD 2200 in correspondence to the protocol of the host device 2100. For example, the host interface 2212 may communicate with the host device 2100 through one of a parallel advanced technology attachment (PATA) protocol, a serial advanced technology attachment (SATA) protocol, a small computer system interface (SCSI) protocol, a serial attached SCSI (SAS) protocol, a peripheral component interconnection (PCI) protocol, and a PCI express (PCI-E) protocol. In addition, the host interface 2212 may perform a disk emulating function of supporting the host device 2100 to recognize the SSD 2200 as a hard disk drive (HDD).

The ECC unit 2213 may generate parity bits based on the data transmitted to the nonvolatile memory devices 2231 to 223n. The generated parity bits may be stored in spare areas of the nonvolatile memory devices 2231 to 223n. The ECC unit 2213 may detect an error of the data read from the nonvolatile memory devices 2231 to 223n. When the detected error falls within a correctable range, the ECC unit 2213 may correct the detected error.

The control unit 2214 may analyze and process a signal (i.e., SGL) inputted from the host device 2100. The control unit 2214 may control the general operations of the SSD controller 2210 in response to a request from the host device 2100. The control unit 2214 may control the operations of the buffer memory device 2220 and the nonvolatile memory devices 2231 to 223n based on firmware for driving the SSD 2200. The RAM 2215 may be used as a working memory for driving the firmware.

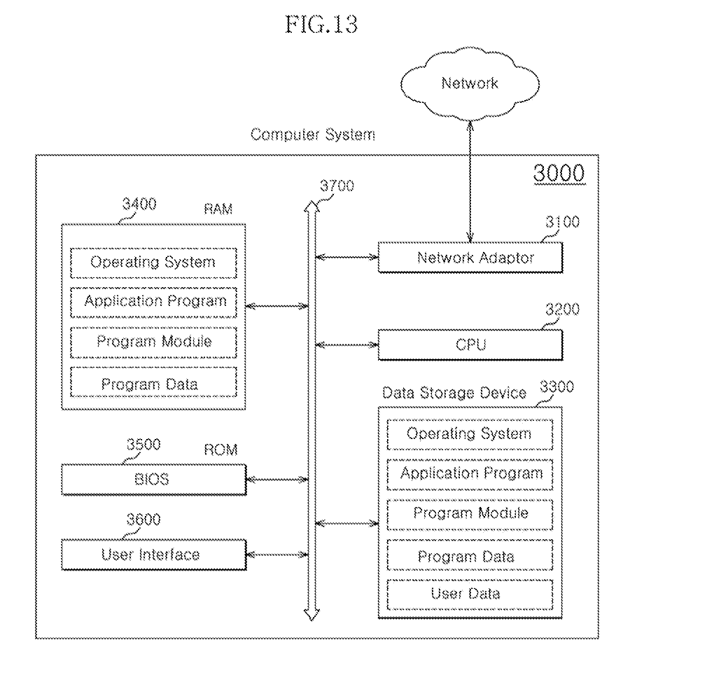

FIG. 13 is a block diagram illustrating a computer system 3000 including the data storage device in accordance with the embodiment of the present invention.

Referring to FIG. 13, the computer system 3000 may include a network adaptor 3100, a central processing unit 3200, a data storage device 3300, a RAM 3400, a ROM 3500 and a user interface 3600, which are electrically coupled to a system bus 3700. The data storage device 3300 may include the data storage device 100 shown in FIG. 3, the data storage device 1200 shown in FIG. 10 or the SSD 2200 shown in FIG. 11.

The network adaptor 3100 provides interfacing between the computer system 3000 and external networks. The central processing unit 3200 performs general operations for driving an operating system residing at the RAM 3400 or an application program,

The data storage device 3300 stores general data used in the computer system 3000. For example, an operating system for driving the computer system 3000, an application program, various program modules, program data and user data are stored in the data storage device 3300.

The RAM 3400 may be used as a working memory device of the computer system 3000. Upon booting, the operating system, the application program, the various program modules and the program data used for driving programs, which are read from the data storage device 3300, are loaded on the RAM 3400. A basic input/output system (BIOS), which is activated before the operating system is driven, is stored in the ROM 3500. Information exchange between the computer system 3000 and a user is implemented through the user interface 3600.

Although not shown in FIG. 13, the computer system 3000 may further include devices such as an application chipset, a cam era image processor, and so forth.

While certain embodiments have been described above, it will be understood to those skilled in the art that the embodiments described are by way of example only. Accordingly, the operating method of a data storage device described herein should not be limited based on the described embodiments. Rather, the operating method of a data storage device described herein should only be limited in light of the claims that follow.

What is claimed is:

1. A method for operating a data storage device, comprising:
grouping memory blocks of a nonvolatile memory device based on program counts or erase counts of the respective memory blocks, into a first group and a second group which has program counts or erase counts larger than the first group;
performing a reprogram operation for memory blocks included in the first group; and
performing a read retry operation for a selected memory cell of a memory block included in the first group or the second group, based on a read retry voltage set for each of the first group and the second group, when an error of data read from the selected memory cell is not correctable.

2. The method according to claim 1, wherein the performing of the reprogram operation comprises:
reading data stored in the memory blocks included in the first group; and
reprogramming read data in free memory blocks.

3. The method according to claim 2, further comprises:
correcting an error of the read data, before the performing of the reprogram operation.

4. The method according to claim 2, wherein the performing of the reprogram operation further comprises:
selecting a memory block from which data are to be read, among the memory blocks included in the first group,

5. The method according to claim 4, wherein the selecting of the memory block comprises:
selecting a memory block which has a smallest program count or erase count, among the memory blocks included in the first group.

6. The method according to claim 4, wherein the selecting of the memory block is sequentially performed for all the memory blocks included in the first group.

7. The method according to claim 1, further comprising:
setting a first read retry voltage corresponding to the first group and setting a second read retry voltage corresponding to the second group.

8. The method according to claim 7, wherein the first read retry voltage is lower than the second read retry voltage.

9. The method according to claim 7, wherein, in the read retry operation, a read operation is performed at least one time by applying a read retry voltage set for a corresponding group in which the selected memory cell is included, to the selected memory cell.

10. A method for operating a data storage device, comprising:
grouping memory blocks of a nonvolatile memory device based on program counts or erase counts of the respective memory blocks, into a first group and a second group which has program counts or erase counts larger than the first group; and
performing a reprogram operation for memory blocks included in the first group.

11. The method according to claim 10, wherein the performing of the reprogram operation comprises:
reading data stored in the memory blocks included in the first group; and
reprogramming read data in free memory blocks.

12. The method according to claim 11, further comprising:
correcting an error of the read data, before the performing of the reprogram operation.

13. The method according to claim 11, wherein the performing of the reprogram operation further comprises:
selecting a memory block from which data are to be read, among the memory blocks included in the first group.

14. The method according to claim 13, wherein the selecting of the memory block comprises:
selecting a memory block which has a smallest program count or erase count, among the memory blocks included in the first group.

15. The method according to claim 13, wherein the selecting of the memory block sequentially performed for all the memory blocks included in the first group.

16. The method according to claim 11, wherein the data storage device performs a wear-leveling operation on the nonvolatile memory device.

17. A method for operating a data storage device, comprising:
grouping memory blocks of a nonvolatile memory device based on program counts or erase counts of the respective memory blocks, into a first group and a second group which has program counts or erase counts larger than the first group; and
setting a first read retry voltage corresponding to the first group and setting a second read retry voltage corresponding to the second group.

18. The method according to claim 17, wherein the first read retry voltage is lower than the second read retry voltage.

19. The method according to claim 17, further comprising:
performing a read operation for a selected memory cell of a memory block included in the first group or the second group; and
performing a read retry operation for the selected memory cell, based on a read retry voltage set for each of the first group and the second group, when an error of data read from the selected memory cell is not correctable.

20. The method according to claim 19, wherein, in the read retry operation, a read operation is performed at least one time by applying a read retry voltage set for a corresponding group in which the selected memory cell is included, to the selected memory cell.
